(19) United States
(12) Patent Application Publication
(10) Pub. No.: US 2024/0424735 A1
(43) Pub. Date: Dec. 26, 2024

(54) SYSTEMS AND METHODS FOR HEATING AND MOUNTING A BUILD PLATE FOR ADDITIVE MANUFACTURING

(71) Applicant: VulcanForms Inc., Burlington, MA (US)

(72) Inventor: Raghav Aggarwal, Somerville, MA (US)

(73) Assignee: VulcanForms Inc., Burlington, MA (US)

(21) Appl. No.: 18/750,585

(22) Filed: Jun. 21, 2024

Related U.S. Application Data
(60) Provisional application No. 63/509,836, filed on Jun. 23, 2023.

(51) Int. Cl. B29C 64/245; B29C 64/153; B29C 64/295; B33Y 10/00; B33Y 30/00

(52) U.S. Cl. CPC B29C 64/245; B29C 64/153; B29C 64/295; B33Y 10/00; B33Y 30/00

(57) ABSTRACT

A mounting system for a build plate of an additive manufacturing system includes a build plate, a build plate support structure, and at least one clamp assembly. The build plate has a build surface and a coupling surface opposite the build surface. The build plate support structure is in supportive contact with the coupling surface of the build plate, and the build plate support structure supports the build plate during an additive manufacturing process. Each clamp assembly has a coupling member extending between the build plate support structure and the build plate, and each coupling member engages with the coupling surface of the build plate. Each clamp assembly resiliently biases the build plate towards the build plate support structure when the coupling member is engaged with the build plate.

### RELATED APPLICATIONS

This application claims priority under 35 U.S.C. § 119(e) to U.S. Provisional Application No. 63/509,836, filed Jun. 23, 2023, the content of which is incorporated by reference in its entirety for all purposes.

### FIELD

Disclosed embodiments are related to SYSTEMS AND METHODS FOR HEATING AND MOUNTING A BUILD PLATE FOR ADDITIVE MANUFACTURING.

### BACKGROUND

In some selective laser melting processes for additive manufacturing, one or more laser spots may be scanned over a thin layer of powdered precursor material that is deposited on a build plate. The powder that is scanned with the laser spot is melted and fused into a solid structure. Once a layer is completed, the structure is indexed, a new layer of powder is laid down and the process is repeated. If an area is scanned with the laser spot on the new layer that is above a previous scanned area on the prior layer, the powder is melted and fused onto the solid material from the prior layer. This process can be repeated many times in order to build up a three-dimensional shape of almost any form.

Both single laser and multi-laser systems are used in selective laser melting processes. Some systems use a pair of galvanometer mounted mirrors to scan each laser beam over the desired pattern on the build surface. Some systems use motion stages to scan the laser over the build surface. Moreover, some systems use a combination of motion stages and galvanometers to scan the laser over the build surface.

### SUMMARY

In some embodiments, a mounting system for a build plate of an additive manufacturing system may comprise a build plate, a build plate support structure, and at least one clamp assembly. The build plate may have a build surface and a coupling surface opposite the build surface. The build plate support structure may be in supportive contact with the coupling surface of the build plate, and the build plate support structure may be configured to support the build plate during an additive manufacturing process. Each clamp assembly may include a coupling member extending between the build plate support structure and the build plate, and each coupling member may be configured to engage with the coupling surface of the build plate. Each clamp assembly may be configured to resiliently bias the build plate towards the build plate support structure when the coupling member is engaged with the build plate.

In other embodiments, a method for additive manufacturing may include disposing a build plate adjacent to a build plate support structure within a build volume of an additive manufacturing system, and engaging at least one coupling member between the build plate support structure and the build plate. The method may further include resiliently biasing the build plate, by the at least one coupling member, toward the build plate support structure.

In further embodiments, an additive manufacturing system may include a build plate support structure comprising a base plate, a build plate mounted to the base plate, and a build plate heating assembly disposed between the build plate and the base plate. The system may further include at least one biasing member disposed between the build plate heating assembly and the base plate. The at least one biasing member may be in biasing contact with the build plate heating assembly to resiliently urge the build plate heating assembly towards the build plate.

In some embodiments, a method for additive manufacturing may include disposing a build plate adjacent to a base plate of a build plate support structure within a build volume of an additive manufacturing system, and resiliently biasing a build plate heating assembly into thermal contact with the build plate. The method may further include heating the build plate, with the build plate heating assembly, from a first temperature to a second temperature. In some such embodiments, the method may further include depositing a layer of powdered material on the build plate, and directing laser energy toward the layer of powdered material to selectively melt at least a portion of the layer of powdered material.

In other embodiments, an additive manufacturing system may include a build plate and a build plate heating assembly thermally coupled to the build plate. The build plate heating assembly may include a first heating sector and at least one further heating sector. The first heating sector may be thermally coupled to a first region of the build plate, and the first heating sector may be configured to output a first heat flux to the first region of the build plate. The at least one further heating sector may be thermally coupled to a further region of the build plate, and the at least one further heating sector may be configured to output a second heat flux to the further region of the build plate. The second heat flux may be different from the first heat flux.

In further embodiments, a method for additive manufacturing may include applying a first heat flux to a first region of a build plate, and applying a second heat flux, different from the first heat flux, to at least one further region of the build plate. The method may further include depositing a layer of material on the build plate, and directing laser energy onto the layer of material to selectively melt at least a portion of the layer of material.

In some embodiments, an additive manufacturing system may include a build volume, a build plate disposed within the build volume, an optics assembly, and a build plate heating assembly. The build plate may include a build surface, and the optics assembly may be configured to direct laser energy toward the build surface. The build plate heating assembly may be thermally coupled to the build plate, and may be configured to change a temperature of the build plate from a first temperature to a second temperature. The build plate may be configured to have an unheated geometry at the first temperature and a heated geometry at the second temperature. The build surface may be non-flat in the unheated geometry and flat in the heated geometry.

In other embodiments, a method for additive manufacturing may include heating a build plate of an additive manufacturing system from a first temperature to a second temperature to transform the build plate from an unheated geometry in which a build surface of the build plate is non-flat to a heated geometry in which the build surface is flat. The method may further include depositing a layer of powdered material on the build surface, and directing laser energy toward the layer of powdered material to melt at least a portion of the layer of material.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

In the drawings, each identical or nearly identical component that is illustrated in various figures may be represented by a like numeral. For purposes of clarity, not every component may be labeled in every drawing. In the drawings:

FIG. 1 is a schematic illustration of an additive manufacturing system, according to one embodiment;

FIG. 2A is cross-sectional view of a build plate mounting assembly with a clamp assembly in a disengaged position, according to one embodiment;

FIG. 2B is cross-sectional view of a build plate mounting assembly with an engagement feature inserted into a socket, according to one embodiment;

FIG. 2C is cross-sectional view of a build plate mounting assembly with a clamp assembly in an engaged position, according to one embodiment;

FIG. 3A is a cross-sectional view of a build plate heating assembly biased towards a build plate, according to one embodiment;

FIG. 3B is a cross-sectional view of a build plate heating assembly biased towards a thermal interface material in contact with a build plate, according to one embodiment;

FIG. 4 is a cross-sectional view of a build plate mounting assembly including a kinematic coupling, according to one embodiment;

FIG. 5A is a bottom view of a build plate including a first set of kinematic coupling features, according to one embodiment;

FIG. 5B is a top view of a build plate support structure including a second set of kinematic coupling features, according to one embodiment;

FIG. 6A is a top view of a build plate coupled to a build plate heating assembly having a single heating sector, according to one embodiment;

FIG. 6B is a temperature profile of the build plate of FIG. 6A;

FIG. 7A is a top view of a build plate coupled to a build plate heating assembly having multiple heating sectors, according to one embodiment;

FIG. 7B is a temperature profile of the build plate of FIG. 7A;

FIG. 8 is a top view of a build plate heating assembly, according to one embodiment;

FIG. 9A is a side view of a build plate in an unheated geometry, according to one embodiment;

FIG. 9B is a side view of the build plate of FIG. 9A in a heated geometry;

FIG. 10A is a side view of a build plate in an unheated geometry, according to one embodiment; and

FIG. 10B is a side view of the build plate of FIG. 10A in a heated geometry.

### DETAILED DESCRIPTION

Some selective laser melting processes include the deposition of a layer of precursor material (e.g., a powdered material) on a build plate. The material is then melted and fused using an appropriate laser system and/or optical system to form a built part in an iterative, layer-by-layer process. The inventors have observed that heating the material to a desired temperature before the melting/fusing steps may reduce stress and/or distortion in the built part. Moreover, the inventors have observed that heating the build plate may be an effective way of heating the material to the desired temperature. Accordingly, the inventors have recognized and appreciated the benefits of an additive manufacturing system which includes a build plate heating assembly including one or more build plate heaters which is physically and/or thermally coupled to the build plate to heat the build plate.

However, the inventors have further observed that operation of a build plate heater may incidentally affect other portions of the system. For example, in systems where the build plate is supported by a support column (e.g., a moveable piston, a static pillar, or other moveable or static support column) and/or other build plate support structure (e.g., a bracket, a coupling, a spacer, a base plate, a load-bearing member, or other support structure), heat from the build plate heater may be transferred to the support column and/or support structure. This may cause thermal expansion in the support column or support structure, resulting in a corresponding displacement of the build plate and any material or part disposed thereon. Such displacement may result in various issues during a build process, including interference between different components of the system, and/or issues in a built part (e.g., delamination, voids, dimensional errors and/or other issues).

In view of the above, the inventors have recognized and appreciated the benefits of an additive manufacturing system which includes one or more heat management components to reduce the thermal effects of a build plate heater on various other system components. For example, in some embodiments, an additive manufacturing system may include at least one of an insulation layer and a cooling plate in thermal communication with the build plate heater to absorb and/or remove heat from the build plate heater. In some embodiments, one or more heat management components may be disposed between a build plate heater and another component of the additive manufacturing system, such as a support column, a sidewall, a support structure, or any other component. Additionally or alternatively, one or more heat management components may be integrated into or form a portion of another component. For example, one or more heat management components (e.g., an insulation layer and/or a cooling plate) may be included in a build plate support structure. In various embodiments, a thermal component such as a build plate heater or heat management component may be physically and/or thermally coupled to a build plate in any appropriate manner. Some heaters may be physically mounted to a build plate using fasteners, clamps, threaded engagements, snap fittings, friction fittings, magnetic coupling, biasing members, adhesives, and/or any other appropriate attachment or combination of attachments.

However, without disparaging or disclaiming the use of any such attachment(s) in a build plate mounting system, the inventors have observed certain drawbacks that may be associated with various ways of mounting a build plate heater to a build plate. For example, some attachments may produce or allow for gaps between the build plate heater and the build plate (for example, as a consequence of the thermal expansion of the build plate, and/or simply by virtue of an imperfect geometric correspondence between the heater and the build plate), which may lead to thermal discontinuities, thermal losses, and less effective heating of the build plate. Further, some attachments may conduct heat from the build plate and/or the build plate heater, thereby reducing the effectiveness of the build plate heater and/or modifying a thermal profile of the build plate. In some instances, the heat conducted from the build plate may further be transferred to other components of the system which are in thermal contact with the attachment. Additionally, some attachments may transmit a bending moment to the build plate, resulting in a bending stress that may distort the build plate. Finally, some attachments may apply forces to the build plate which may change a position and/or orientation of the build plate from a desired position and/or orientation. The inventors have observed that any of these effects, including any deviations from a desired thermal profile, position, orientation, and/or shape of a build plate may result in issues during a build process and/or in a built part (e.g., dimensional errors, voids, delamination, and/or other issues).

In view of the above, the inventors have recognized and appreciated the benefits of various features of an additive manufacturing system and/or a build plate heater mounting system thereof that may reduce and/or mitigate the issues noted above. In some embodiments, biasing members may be included to improve the uniformity of physical and/or thermal contact across an interface between a build plate and a build plate heater, for example by reducing the occurrence of gaps. In some embodiments, one or more biasing members may be included to bias the build plate toward the build plate heater. Additionally or alternatively, one or more biasing members may be included to bias a build plate heating assembly or a build plate heater thereof towards a build plate.

In some embodiments, a clamp assembly may be included in the mounting system to clamp a build plate together with a build plate support structure, a build plate heating assembly, a build plate heater, and/or any other appropriate component(s). In some embodiments, the clamp assembly may include a biasing member (e.g., a spring) to resiliently bias the build plate towards the build plate heating assembly, build plate heater, and/or build plate support structure. Some clamp assemblies may be configured to bias the build plate without applying a bending moment to the build plate, or while applying only a small bending moment to reduce a resulting distortion in and/or displacement of the build plate. For example, in some embodiments, a clamp assembly may include a coupling member configured to apply a biasing force along a central axis of the coupling member to reduce a bending moment imparted to the build plate. Further, in some embodiments, a clamp assembly may extend at least partially through a build plate support structure, build plate heating assembly, and/or build plate heater.

Furthermore, in some embodiments, a clamp assembly may be configured to facilitate the positioning and/or orientation of a build plate within the additive manufacturing system. In some embodiments, a clamp assembly may be configured to guide the build plate or a portion thereof into a desired position and/or orientation relative to another portion of the additive manufacturing system (e.g., the build plate support structure, support column, or other portion of the system). For example, in some embodiments, a build plate may include one or more plate-side reference features on a coupling surface of the build plate, and one or more mounting-side reference feature may be included in a build plate support column, a build plate support structure, a clamp assembly, and/or any other appropriate portion of an additive manufacturing system. Each mounting-side reference feature may be configured to cooperate with a respective plate-side reference feature to establish a position and/or orientation of the build plate. In some embodiments, a clamp assembly may be configured to engage with the coupling surface to bias plate-side reference into contact or engagement with the mounting-side reference feature. Further, in some embodiments, a build plate mounting system may include a kinematic coupling in which three plate-side reference features cooperate with three mounting-side reference features to form a kinematic coupling to fix the position and orientation of the build plate in six degrees of freedom. In some embodiments, each pair of reference features may cooperate to create two point contacts. In addition to constraining the build plate, these point contacts may allow only negligible heat to be conducted from the build plate to the clamp assembly, thereby reducing thermal losses from the build plate.

Additionally, in some embodiments, one or more biasing members may cooperate with the build plate heating assembly to bias the heating assembly or a portion thereof toward the build plate. For example, one or more springs may cooperate with a build plate heater to bias the build plate heater toward the build plate. This biasing arrangement may be included instead of or in addition to the biasing of the build plate described above. In other words, in various embodiments, a build plate may be biased towards a heater, a heater may be biased towards a build plate, or each of the heater and the build plate may be biased towards the other.

In addition to or instead of the biasing features discussed above, a thermal interface material may be provided between the build plate and the build plate heater to improve the thermal contact therebetween. In some embodiments, a thermal interface material may be compliant to allow deviation in the relative positioning between the build plate and the heater without creating a gap or thermal discontinuity. In various embodiments, any appropriate thermal interface material may be disposed between a build plate and a build plate heating assembly or build plate heater, including any appropriate silicone, metallic mesh or wool (e.g., copper wool, copper mesh, or others), graphite (e.g., expanded graphite sheets), and/or any other appropriate thermal interface material.

Further to the above, the inventors have observed that the application of heat to a build plate may have additional effects on the build plate. For example, heating a build plate may result in temperature gradients across the build plate. In particular, the inventors have observed that the application of a uniform heat flux across a region of the build plate (for example, where a single heater is used) may produce a temperature gradient in which a central portion of the region of the build plate is hotter than an outer or peripheral portion of the region or build plate. In other words, a single uniform heat flux may produce a “hot spot” at the center of the heat flux area, with peripheral areas experiencing a smaller change in temperature. This gradient may cause undesired distortion in the build plate, which may result in issues during a build process and/or in a built part.

In view of the above, the inventors have recognized and appreciated the benefits of a build plate heating assembly capable of applying different heat fluxes to different regions of the build plate. For example, a build plate heating assembly according to the present disclosure may apply a first heat flux to a first region of the build plate, and a second heat flux to at least one further region of the build plate. In some embodiments, the first region may include a central region of the build plate, and the at least one further region may include one or more peripheral regions. Further, in some such embodiments, the first heat flux may be less than the second heat flux. This reduced heat flux in the central region(s) relative to the peripheral region(s) may reduce or prevent a “hot spot” in the central region(s) as described above. In other embodiments, a central region may have a higher heat flux than a peripheral region, as any region of a build plate may have any desirable heat flux. These differential heat fluxes may be achieved in any appropriate way. For example, in some embodiments, a single heater may be configured to produce different heat fluxes in different regions (for example, by including a heating coil of varying coil density in different regions). In some embodiments, a build plate heating assembly may include two or more heaters, with each heater of the assembly configured to independently produce a respective heat flux.

Further to the above, the inventors have observed that a build plate may have a first geometry before the application of heat (i.e., an unheated geometry), and may transform into a second geometry as a result of thermal expansion (i.e., a heated geometry), with differences between the unheated and heated geometries being significant in some applications. In particular, the inventors have observed that thermal expansion may cause various portions of a build plate to expand at different rates and/or to varying degrees. As a result, a build surface of the build plate which may have had a flat profile in the unheated geometry may have a concave or otherwise non-flat profile in the heated geometry. Similarly, a side surface of the build plate which had been vertical (i.e., orthogonal to the build surface or a reference datum such as a horizontal plane) in an unheated geometry may be slightly angled and/or curved in a heated geometry. These angled and/or curved sides may cause interference between the build plate and adjacent components of an additive manufacturing system, such as a shroud surrounding the build plate, an adjacent or surrounding base plate or support plate, a seal, or any other system component.

In view of the above, the inventors have recognized and appreciated the benefits of an additive manufacturing system which includes a build plate that is configured to expand from an unheated geometry into a heated geometry in which a build surface of the build plate is substantially flat (e.g., wherein a maximum deviation from a flat datum is less than 1.0 mm). In various embodiments, the unheated geometry may include any appropriate geometric features, depending on the shape, size, and/or thermal properties of the build plate. For example, in some embodiments, the build surface may be convex in the unheated geometry, such that the concaving effect of thermal expansion may result in a flat build surface in the heated geometry. Additionally, in some embodiments, a side of a build plate may be formed with an angle and/or a curvature in the unheated geometry, such that the thermal expansion may result in the side being orthogonal to the build surface in the heated geometry.

In some embodiments, a build plate may be in a unheated geometry at any desirable temperature and/or pressure, including ambient conditions (e.g., room temperature of 15-30° C. and atmospheric pressure), standard temperature and pressure (STP, e.g., 0° C. and 1.0 atmosphere), low pressure (e.g., in a vacuum), high pressure, and/or any other appropriate temperature and/or pressure. Additionally or alternatively, in some embodiments, a build plate may be in a heated geometry at any desirable temperature and/or pressure. For example, in some embodiments, a build plate may be in the heated geometry at 150° C., 200° C., 300° C., 500° C., and/or under any other appropriate temperature. In addition to these temperatures, a build plate may be in the heated geometry at any appropriate pressure, including ambient or atmospheric pressure, vacuum conditions, and/or a pressurized environment. Although particular values or ranges for temperatures and pressures may be described herein, it will be appreciated that temperatures and pressures both greater than and less than those described are also contemplated as the disclosure is not limited in this regard. Further, it will be appreciated that any of the embodiments described or contemplated herein, including any of the systems or methods described, may be used at any appropriate temperature and/or pressure, including those described immediately above, as the inclusion of particular temperatures and pressures does not limit these conditions to being associated with any particular embodiment.

It will be appreciated that any embodiments of the systems, components, methods, and/or programs disclosed herein, or any portion(s) thereof, may be used to form any part suitable for production using additive manufacturing. For example, a method for additively manufacturing one or more parts may, in addition to any other method steps disclosed herein, include the steps of selectively fusing one or more portions of a plurality of layers of precursor material deposited onto the build surface to form the one or more parts. This may be performed in a sequential manner where each layer of precursor material is deposited on the build surface and selected portions of the upper most layer of precursor material is fused to form the individual layers of the one or more parts. This process may be continued until the one or more parts are fully formed.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

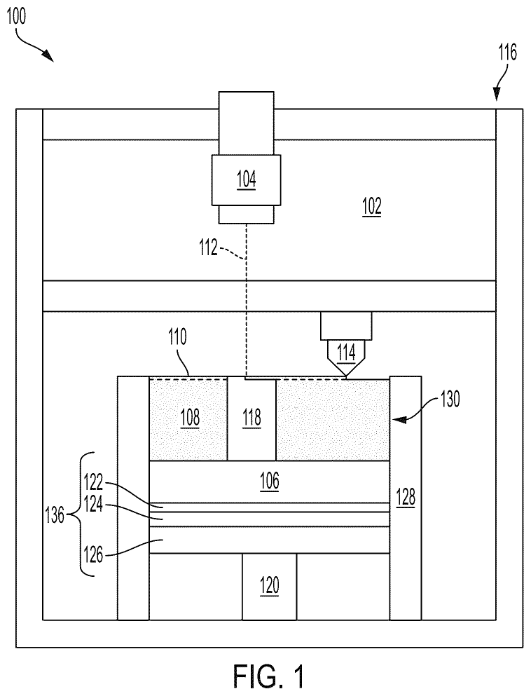

FIG. 1 shows a schematic depiction of an additive manufacturing system 100 according to one embodiment. The additive manufacturing system 100 may comprise a build chamber 102 that contains an optics assembly 104 and a recoater assembly 114 moveably suspended above a build plate 106. The build plate 106 may be surrounded by a shroud 128, which may cooperate with the build plate to define a build volume 130, and the recoater system 114 may be configured to deposit a precursor material 108 in the build volume 130. In some embodiments, the shroud may include thermal insulation to reduce an amount of heat transferred from the build plate and/or build plate heating assembly to various other components of the system via the shroud. The precursor material 108 may be any appropriate material for additive manufacturing, including any appropriate plastic, metal, polymer, composite, or other powdered or non-powdered material. In some embodiments, the build plate 106 may be supported by one or more build plate support columns 120.

The additive manufacturing system 100 may be configured to allow for relative movement between the build plate 106 and the shroud 128 in order to adjust a height of the build volume throughout a build process. In some embodiments, the build plate support column 120 may be configured to move the build plate 106 relative to the shroud 128. For example, the build plate support column may include a piston operably connected to an actuator. Additionally or alternatively, the build plate support column may be configured to hold the build plate static while the shroud moves relative to the build plate.

The optics assembly 104 may include one or more optical components configured to direct laser energy 112 through the optics assembly 104 toward the build plate 106 and/or build volume 130. Further, the optical system 104 may be configured to scan the light energy 112 across various portions of the build plate and/or build volume. In some embodiments, the optics assembly may include a galvanometer system configured to scan the light energy across the build plate and/or build volume. Additionally or alternatively, in some embodiments, the optics assembly or a portion thereof may be moveable relative to the build plate by a gantry system 116.

In some embodiments, a build plate 106 may be mounted to and/or supported by a build plate support structure 136, which may be mounted to and/or supported by the build plate support column 120. A build plate support structure may include any component on which a build plate may be mounted, directly or indirectly. In some embodiments, a build plate support structure may include one or more components configured to facilitate positioning and/or orientation of a build plate within the build chamber 102 or on the build plate support column 120. Additionally or alternatively, a build plate support structure may include one or more thermal components, such as a build plate heating assembly 122, an insulating layer 124, and/or a cooling plate 126.

A build plate may be mounted to a build plate support structure and/or a build plate support column in any appropriate manner. In some embodiments, a build plate may be mounted to a build plate support structure and/or a build plate support column such that the build plate is biased towards the build plate support structure, for example to improve a thermal contact between the build plate and the build plate support structure, and/or to facilitate disposing the build plate in a desired position and/or orientation. Additionally or alternatively, the build plate support structure may be configured to couple to the build plate such that that build plate support structure or a portion thereof is biased toward the build plate.

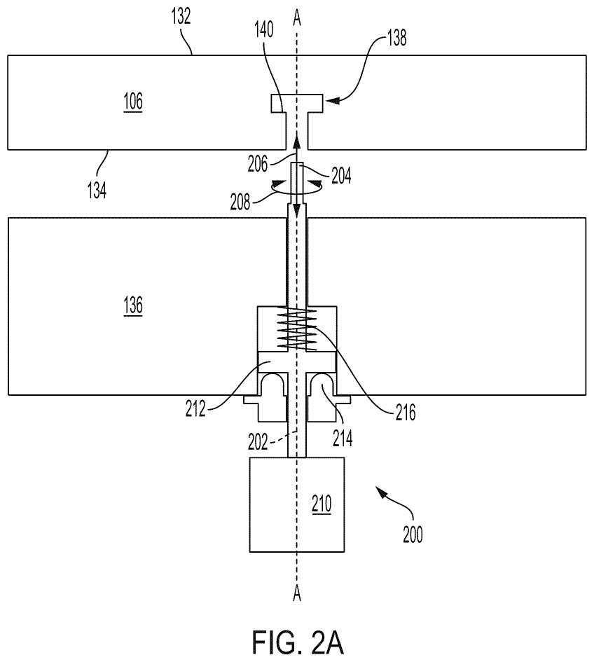

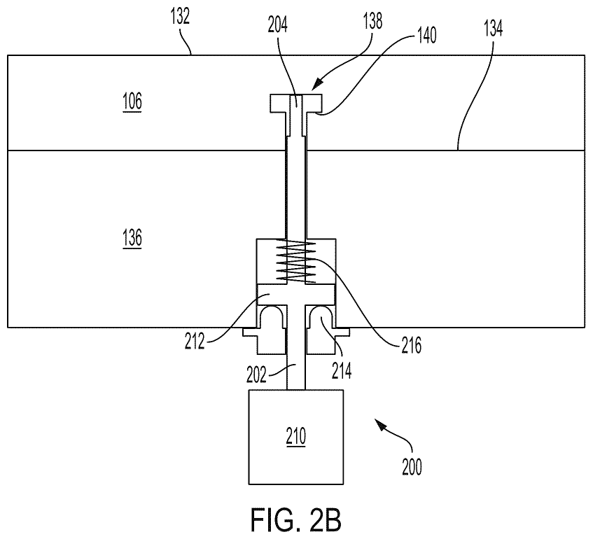

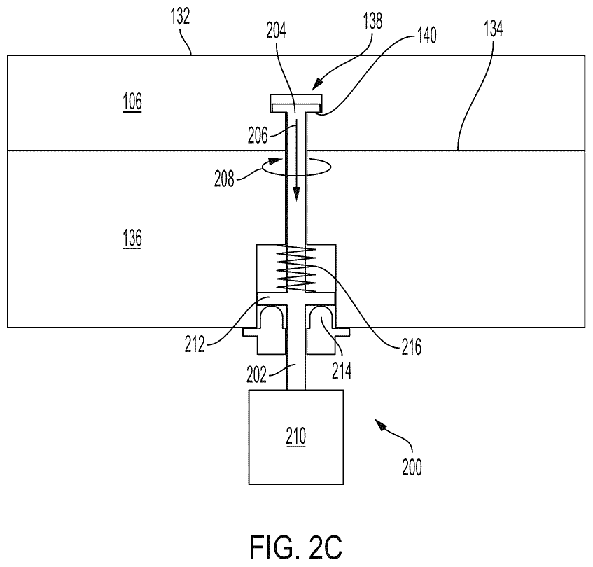

FIGS. 2A-2C show one example of an attachment for coupling a build plate to a build plate support structure. In some embodiments, a build plate 106 may include a build surface 132 and a coupling surface 134 opposite the coupling surface. The build surface 132 may be configured to receive one or more layers of precursor material, for example by including a desired profile and/or geometry (e.g., a flat profile to facilitate uniform layer thickness). The coupling surface may be configured to engage with a build plate support structure, a build plate mounting system, and/or a build plate support column. In some embodiments, the coupling surface include one or more coupling features to facilitate coupling between the build plate and another component. For example, in the embodiment shown, the coupling surface 134 may include one or more sockets 138, which may be a hole or cavity in the build plate, extending from the coupling surface into the build plate. In the embodiment shown, a socket 138 may be formed as a stepped cylindrical hole in the coupling surface 134.

In some embodiments, a build plate mounting system may include a clamp assembly 200. The clamp assembly 200 may cooperate with or be formed as part of a build plate support structure 136 and/or a build plate support column. In the embodiment shown, the clamp assembly 200 may extend at least partially through the build plate support structure 136. The clamp assembly may include a coupling member configured to engage with the coupling surface 134 or a coupling feature thereof (e.g., the socket 138, which may include an engagement notch 140 configured to engage with the engagement feature 204) to control or influence the positioning and/or orientation of the build plate with respect to the build plate support structure. In the embodiment shown, the clamp assembly 200 may include a rod 202 having an engagement feature 204 formed at a first end portion of the rod. The engagement feature 204 may be configured to engage with the coupling surface 134 or a portion thereof. For example, in the embodiment shown, the engagement feature 204 may be formed in a T-shape sized and shaped to insert into and engage with the stepped cylindrical hole of the socket 138.

In some embodiments, the clamp assembly or a portion thereof (e.g., rod 202) may be configured to selectively engage with the build plate or a coupling feature thereof by moving between an engaged position and a disengaged position. In the engaged position, the clamp assembly may be engaged with the coupling surface and/or coupling feature thereof. In the disengaged position, the clamp assembly may be disengaged from the coupling surface and/or coupling feature. In some embodiments, the clamp assembly and/or rod may be configured to move between the engaged position and the disengaged position by translating and/or rotating. For example, in the embodiment shown, the rod 202 may be configured to translate along an axial direction 206 of the rod 202 and/or rotate about a central axis of the rod, as indicated by arrow 208. In some embodiments, a clamp assembly may include or be operably coupled to an actuator, which may be configured to move the clamp assembly or portion thereof between an engaged position and a disengaged position. For example, in the embodiment shown, a second end portion of the rod 202 may be operably coupled to at least one actuator 210. The actuator 210 may be configured to translate and/or rotate the rod 202. In some embodiments, the actuator may be configured to both translate and rotate the rod, either sequentially or concurrently. For example, in the embodiment shown, the rod may include a cam 212, which may have a face which slopes in a circumferential direction around the rod 202. The sloped face of the cam 212 may be biased into contact with a cam follower 214 by a spring 216. The actuator 210 may be a rotational actuator configured to rotate the rod 202 about its central axis. The camming interaction between the sloped face of the cam 212 and the cam follower 214 may cause the rod 202 to translate along its central axis as a result of the rotation caused by the actuator 210.

FIGS. 2A-2C depict a sequence by which the clamp assembly 200 may engage with the build plate 106. As shown in FIG. 2A, the build plate 106 may be positioned relative to the support structure 136 such that the socket 138 is axially aligned with the clamp assembly 200, the rod 202, and/or the engagement feature 204, for example along central axis A-A. As shown in FIG. 2B, a portion of the clamp assembly 200 (e.g., the rod 202 and/or engagement feature 204) may be extended into the socket 138, for example by moving the build plate 106 towards the build plate support structure 136 and/or by extending the portion of the clamp assembly towards the build plate (e.g., by operating the actuator 210). As shown in FIG. 2C, the rod and/or the engagement feature may be moved into an engaged position in which the clamp assembly is engaged with the socket, for example by engaging the engagement feature 204 with the engagement notch 140. In some embodiments, moving the clamp assembly into the engaged position may include rotating and/or translating a portion of the clamp assembly. For example, as shown in FIG. 2C, the actuator 210 may rotate the rod 202 and the engagement feature 204 in the direction of arrow 208. The camming interaction between the cam 212 and the cam follower 214, in cooperation with a biasing force from the spring 216 against the cam 212 in the direction of arrow 206, may cause the rotation to result in a corresponding translation of the rod 202 and the engagement feature 204 in the direction of arrow 206 (i.e., in an axial direction of the rod). The bias-driven translation of the rod 202, and in particular the biased cooperation of the engagement feature 204 with the engagement notch 140, may cause the clamping mechanism to bias the build plate 106 toward the build plate support structure 136. Further, in some embodiments, the clamp assembly may be configured to selectively move an engagement member (e.g., the rod 202) between an engaged position and a disengaged position, such that a build plate may be removed and replaced after a build process is terminated.

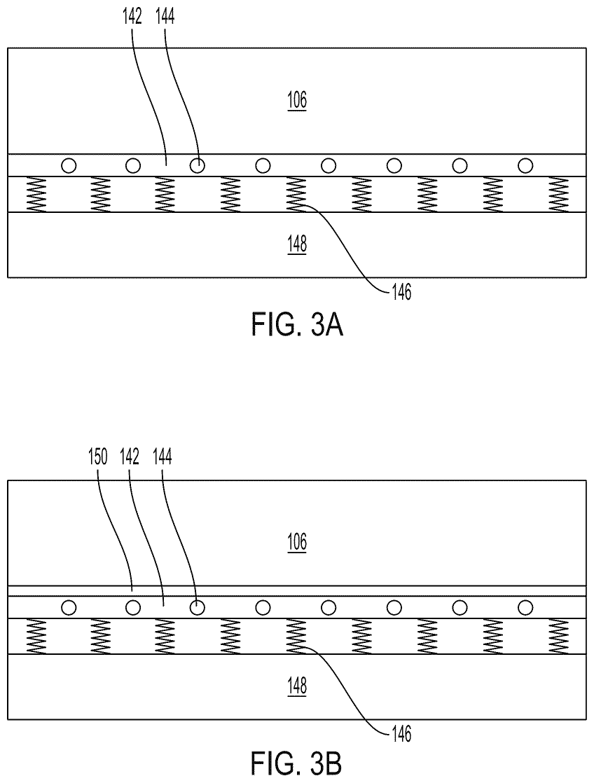

In some embodiments, in addition to or instead of biasing the build plate toward the build plate support structure as described above, the build plate heating assembly may be biased towards the build plate. For example, in the embodiment of FIGS. 3A-3B, the build plate 106 may be in contact with a build plate heating assembly 142 of a build plate support structure. In some embodiments, a build plate heating assembly may include any appropriate type of heater, including any appropriate resistive heater, conductive heater, radiative heater, inductive heater, electric heater, ceramic heater, cartridge heater, a heater carrying a heat transfer fluid, and/or any other appropriate heater or combination of heaters. In the embodiment shown, the build plate heating assembly 142 may include one or more heating plates, each heating plate having one or more heating coil 144 extending therethrough.

In some embodiments, the build plate heating assembly (or other portion of a build plate support structure) may be biased towards the build plate using one or more biasing members such as springs 146 in order to facilitate, improve, and/or maintain contact between the build plate heating assembly and the build plate. Although the depicted embodiment includes mechanical compression springs, it will be appreciated that a biasing member may be any other appropriate component configured to provide a biasing force, including a pneumatic spring, a gas spring, a flexure spring (e.g., a leaf spring), a layer of resilient material, and/or any other appropriate biasing member or combination of biasing members. In the embodiment shown, each spring 146 may be fixed at a first end to another portion of the build plate support structure, such as a base plate 148, which may be configured to provide a static point from which the spring force may be generated. In some embodiments, each spring may be fixed at the first end to any other appropriate portion of a build plate support structure, a build plate support column, or any other appropriate portion of an additive manufacturing system.

Further to the above, a thermal interface material may optionally be included at the interface between the build plate and the build plate heating assembly to further facilitate, improve and/or maintain thermal contact therebetween. In some embodiments, a thermal interface material may include any material configured to conduct heat between the build plate and the heating assembly, including any appropriate thermal paste, thermal tape, thermal gel, thermal adhesive, thermal pad, any appropriate metal or alloy material (e.g., copper, aluminum, zinc, or others, which may be implemented in any appropriate form such as a plate, a wool, a mesh, a foil, or others), or any other appropriate material. In some embodiments, a thermal interface material may include a material which is both thermally conductive and physically compliant, such as silicone, thermal grease, extruded graphite (e.g., extruded graphite sheets or pads), polyimide, and/or any other compliant thermal interface material. For example, the embodiment of FIG. 3B may include a compliant thermal interface material 150, which may be a layer of silicone, disposed between the build plate heating assembly 142 and the build plate 106.

In some embodiments, in addition to the thermal benefits discussed above, a biased engagement between a build plate and a build plate support structure may facilitate the positioning and/or orientation of the build plate. For example, in embodiments in which the build plate is biased towards the build plate support structure, the biasing force may contribute to constraining the build plate in one or more degrees of freedom. In some embodiments, a build plate may be constrained in six degrees of freedom in order to precisely fix a position and orientation of the build plate. For example, in some embodiments, an additive manufacturing system may include a kinematic coupling between the build plate and another portion of the system (e.g., a build plate support structure, build plate support column, and/or any other appropriate portion of the system).

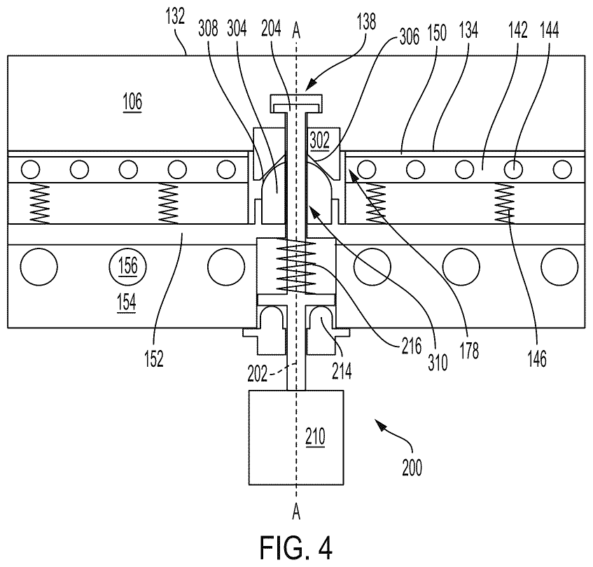

In some embodiments, a clamp assembly may be configured to facilitate the positioning and/or orientation of the build plate. For example, the clamp assembly may facilitate a coupling between a plate-side reference feature and a mounting-side reference feature. In the embodiment of FIG. 4, a plate-side reference feature may comprise a first kinematic coupling feature 302. The first kinematic coupling feature 302 may be disposed on or formed as part of the coupling surface 134 of the build plate 106, and may include a concave surface or a V-groove 306. Further, a mounting-side reference feature may comprise a second kinematic coupling feature 304. In various embodiments, a second kinematic coupling feature or other mounting-side reference feature may be disposed on or formed as part of the build plate support structure, build plate support column, and/or any other portion of an additive manufacturing system to which a build plate may be coupled. In the embodiment shown, the second kinematic coupling feature 304 is provided as part of the build plate support structure 136, and includes a hemispherical surface 308.

In some embodiments, a clamp assembly may be configured to extend through a set of kinematic coupling features such that a biasing force provided by the clamp assembly resiliently urges the kinematic coupling features together. In the embodiment shown, the rod 202 may extend through a through-hole 310 formed in the second kinematic coupling feature 304. Further, the socket 138 may be formed through the first kinematic coupling feature 302, such that the rod 202 may be extended through the first kinematic coupling feature 302. In some embodiments, the through-hole in the second kinematic coupling may be formed through an apex of the hemispherical surface 308, and the coupling hole in the first kinematic coupling feature may be formed through a nadir or deepest point of the V-groove 306 (i.e., through an actual or hypothetical convergence point of the two sides of the V-groove). In this regard, an axial biasing force applied by the clamp assembly 200 may urge the first kinematic coupling feature towards the second kinematic coupling feature along a common central axis A-A.

In some embodiments, a pair of reference features (e.g., a kinematic coupling or a portion thereof) may extend through a build plate heating assembly and/or other portion of a build plate support structure. For example, at least one of a plate-side reference feature and a mounting-side reference feature may extend at least partially into and/or through a build plate heating assembly. In the embodiment shown, the first kinematic coupling feature 302 may extend from the build plate 106 into a gap 178 formed in the build plate heating assembly. Additionally or alternatively, the second kinematic coupling feature 304 may extend from the insulation layer 152 (or any other appropriate portion of the build plate support structure, for example the cooling plate 154 and/or a base plate) into the gap 178.

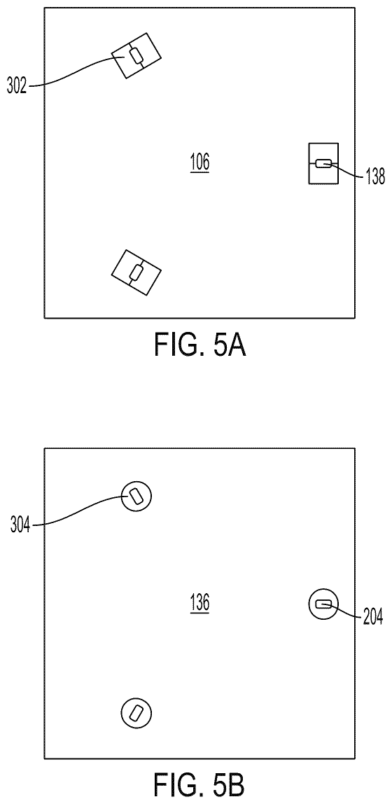

Engagement between the kinematic coupling features shown in FIG. 4 may result in two point contacts between the build plate 106 and the build plate support structure. As will be appreciated with reference to FIGS. 5A-5B, an additive manufacturing system may include three sets of kinematic coupling features, each creating a pair of point contacts to constrain the build plate 106 against the build plate support structure 136.

Returning to FIG. 4, it can be seen that a build plate support structure may include an insulation layer 152 physically and/or thermally coupled to a build plate heating assembly 142 to prevent heat form the build plate heating assembly from diffusing to one or more other portions of the additive manufacturing system (e.g., a build plate support column). In some embodiments, the insulation layer 152 may be spaced apart from the build plate heating assembly 142, for example to provide a space for springs 146. In other embodiments, an insulation layer may be in direct physical contact with a build plate heating assembly, or may be separated from the build plate heating assembly by any other appropriate material(s) or layer(s). In some embodiments, the insulation layer may be any appropriate insulating material, including any appropriate ceramic, glass, fiberglass, aerogel, and/or any other appropriate material or combination of materials.

Additionally or alternatively, in some embodiments, a cooling plate 154 may be in physical and/or thermal contact with a build plate heating assembly, an insulation layer, and/or any other appropriate portion of an additive manufacturing system. The cooling plate 154 may be configured to transfer heat from the build plate heating assembly 142 away from one or more other portions of the additive manufacturing system (e.g., a build plate support column). For example, in some embodiments, the cooling plate 154 may include one or more cooling channels 156, which may be configured to carry a cooling fluid. The cooling fluid may be configured to conduct heat from the cooling plate to carry the heat away from the cooling plate. In some embodiments, the cooling plate may be formed from any appropriate material, including any appropriate copper, aluminum, steel, and/or any other appropriate material or combination of materials. Additionally, in some embodiments, the cooling fluid may include air, water, oil, coolant, and/or any other appropriate fluid or combination of fluids.

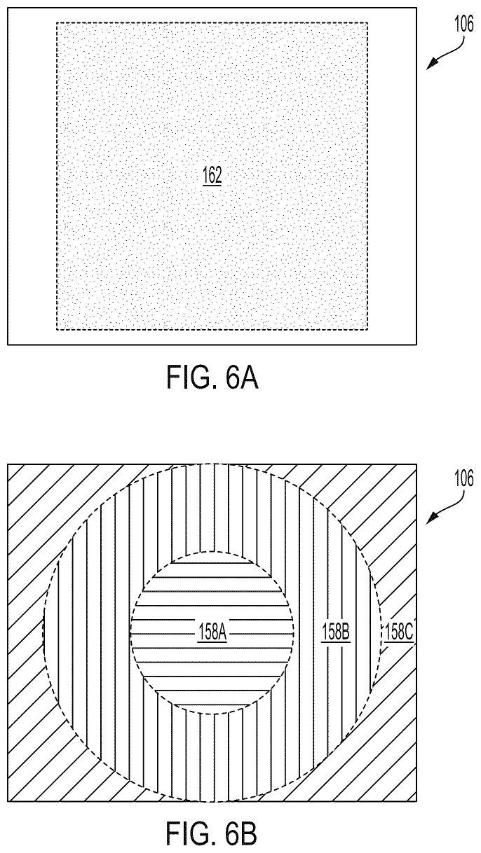

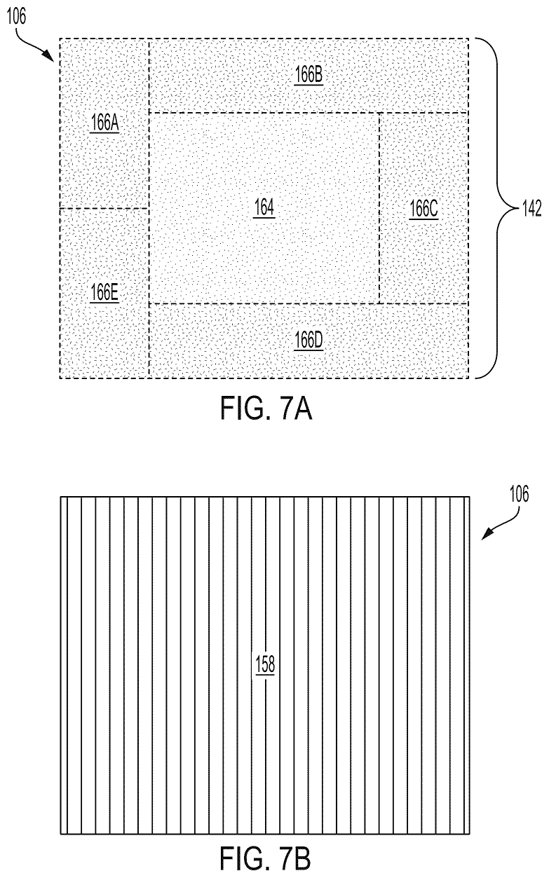

As will be appreciated with reference to FIGS. 6A-7B, the construction and arrangement of a build plate heating assembly 142 may influence a temperature profile of a build plate 106. In some embodiments, a build plate heating assembly may include any appropriate number of heating sectors, with each heating sector configured to allow an output heat flux thereof to be individually selected and/or controlled. For example, in the embodiment of FIG. 6A, a build plate heating assembly may include a singer heating sector 162 configured to output a substantially uniform heat flux across the heating sector 162. FIG. 6B depicts a resulting temperature profile in the build plate 106, in which a central region 158A of the build plate 106 may exhibit a higher temperature than a surrounding region 158B, which may in turn exhibit a higher temperature than a peripheral region 158C.

In some embodiments, a build plate heating assembly may include multiple heating sectors collectively configured to produce a substantially uniform temperature profile across a build plate. Each heating sector may be physically and/or thermally coupled to a respective region of the build plate and may be configured to apply a selected heat flux to the associated region. In some embodiments, each heating sector may include a respective heater of the build plate heating assembly. Additionally or alternatively, an individual heating sectors may include a portion of a heater. For example, some heaters may include various portions with individually controllable and/or selectable heat fluxes.

In the embodiment of FIG. 7A, a first heating sector 164 may be physically and/or thermally coupled to a first region of the build plate 106, and one or more further heating sectors 166A-D physically and/or thermally coupled to one or more further regions of the build plate. In some embodiments, the first heating sector 164 may be configured to apply a first heat flux to the first region. Further, in some embodiments, each further heating sector (e.g., second heating sector 166A, third heating sector 166B, fourth heating sector 166C, fifth heating sector 166D, and/or any additional heating sectors) may be configured to apply a respective heat flux to the associated further region of the build plate. In the embodiment shown, the first heating sector 164 may be a central heating sector coupled to a central region of the build plate, while each further heating sector 166A-D may be a respective peripheral heating sector coupled to a respective peripheral region of the build plate. Further, in the embodiment shown, the central heating sector 164 may be configured to apply a first heat flux to the central region of the build plate which may be less than a second heat flux applied by at least one of the further heating sectors to the associated peripheral region. In some embodiments, the further heating sectors may each be configured to apply substantially the same heat flux to their respective region(s), although it will be appreciated that each heating sector may be configured to apply any appropriate heat flux to an associated region. The reduced heat flux in the central region of the build plate relative to the peripheral region(s) may facilitate a more uniform temperature profile across the build plate 106, for example as shown in FIG. 7B.

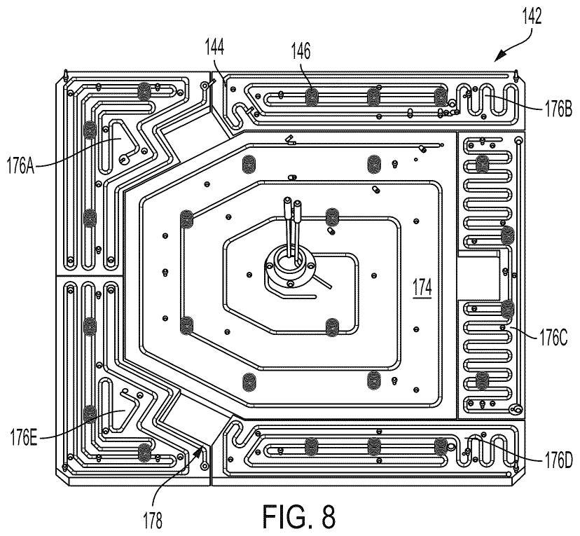

As noted above, in various embodiments, a build plate heating assembly having multiple heating sectors may include a single heater with multiple sectors, or may include multiple heaters. In embodiments with multiple heaters, each heater may be associated with a respective heating sector, or each heater may be associated with multiple heating sectors. In the embodiment of FIG. 8, the build plate heating assembly includes a plurality of heaters, each associated with a single heating sector. For example, a central heater 174 may be associated with central heating sector (e.g., the central heating sector 164 of FIG. 7A) to apply a first heat flux to a central region of the build plate, while each further heater (e.g., second heater 176A, third heater 176B, fourth heater 176C, fifth heater 176D, and/or any additional heaters) may be associated with a respective further heating sector to apply a respective heat flux to a respective further region of the build plate.

In some embodiments, the first heat flux may be less than the second heat flux, such that a heat applied to the central region may be less than a heat applied to the peripheral region(s). In this regard, in the embodiment of FIG. 8, each heater 174, 176A-D may include a heating coil 144 having any appropriate coil density to achieve a desired heat flux. For example, the central heater 174 may have a coil density that is less than a coil density of a peripheral heater 176A-D to produce a correspondingly lower heat flux from the central heater 174.

Further, in some embodiments, the build plate heating assembly may be coupled to the build plate in any appropriate manner, including any of the biased arrangements described herein. Accordingly, each heater may be individually biased towards the build plate, for example by one or more springs 146, which may be implemented according to any of the arrangements described herein. Additionally or alternatively, in some embodiments, a clamp assembly and/or kinematic coupling may be included as described herein. In some such embodiments, a build plate heating assembly may be formed having a gap 178 formed in or between one or more heaters of the build plate heating assembly to allow a clamp assembly and/or set of kinematic coupling features to extend through the build plate heating assembly.

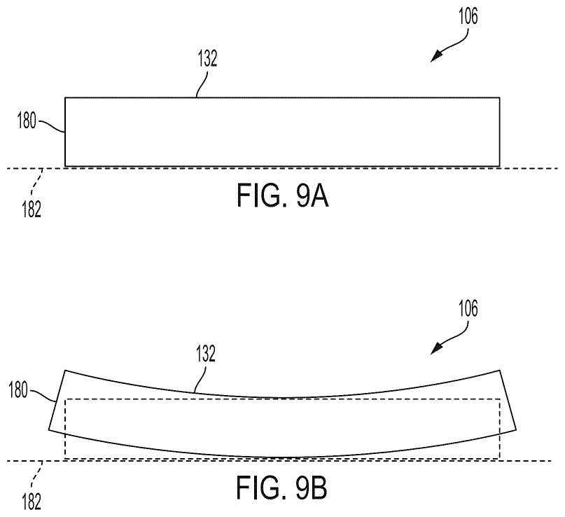

As shown in FIGS. 9A-9B, thermal expansion of a build plate may result in distortion of the build plate and/or a build surface thereof. For example, the build plate 106 of FIG. 9A may be in an unheated geometry in which the build surface 132 is substantially flat. In some embodiments, the build plate 106 may be in the unheated geometry under ambient conditions (e.g., room temperature of 15-30° C.), or at standard temperature and pressure (STP, e.g., 0° C. at 1.0 atmosphere). However, upon application of heat (e.g., by any of the build heating assemblies described herein, or by any other appropriate heat source), the build plate 106 may transition to the heated geometry of FIG. 9B. In some embodiments, the build plate 106 may be in the heated geometry under any desirable conditions. For example, in some embodiments, a build plate may be in the heated geometry at 150° C., 200° C., 300° C., 500° C., and/or under any other appropriate condition.

As can be seen from FIG. 9B, a heated geometry may include some distortion of the build plate 106 and/or the build surface 132. For example, the heated build surface 132 may have an increased concavity as compared to the unheated build surface. Additionally, a side surface 180 of the build plate may be orthogonal with respect to a reference datum (e.g., a horizontal plane 182) in an unheated geometry. However, the side surface 180 may be disposed at a non-orthogonal angle with respect to the reference datum in the heated geometry. As will be appreciated, these effects may be present when heat is applied to the build plate at a location distant from the build surface, for example when a build plate heating assembly applies heat to a coupling surface on an opposing side of the build plate from the build surface 132 such that the coupling surface may undergo greater thermal expansion than the build surface.

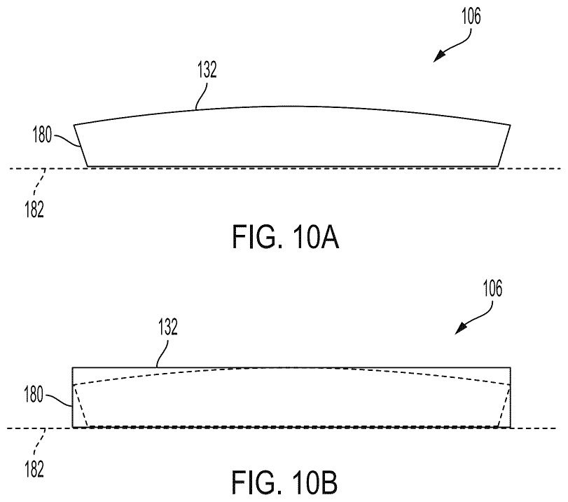

Although the above effects may be at least partially mitigated by the build plate heating assemblies and/or the attachment systems described herein, a build plate may additionally or alternatively be formed in an unheated geometry that may be configured to expand into a desired heated geometry. For example, as shown in FIG. 10A, a build plate 106 may be formed such that the build surface 132 may be at least partially non-flat in the unheated geometry. In some embodiments, the build plate 106 may be formed such that the build surface 132 is at least partially convex. This convexity may counteract the concaving effect of thermal expansion, resulting in a build surface 132 which may be substantially flat in the heated geometry, as shown in FIG. 10B. Additionally or alternatively, a side surface 180 may be formed at a non-orthogonal angle with respect to a horizontal plane 182 in the unheated geometry of FIG. 10A, such that the side surface 180 may be orthogonal to the horizontal plane in the heated geometry of FIG. 10B.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

1.-54. (canceled)

55. An additive manufacturing system, comprising:
a build plate; and
a build plate heating assembly thermally coupled to the build plate, the build plate heating assembly comprising:
a first heating sector thermally coupled to a first region of the build plate, the first heating sector configured to output a first heat flux to the first region of the build plate, and
at least one further heating sector thermally coupled to a further region of the build plate, the at least one further heating sector configured to output a second heat flux to the further region of the build plate, the second heat flux different from the first heat flux.

56. The system of claim 55, wherein the first region of the build plate is a central region of the build plate, and wherein one or more of the at least one further regions is a peripheral region of the build plate.

57. The system of claim 55, wherein the at least one further heating sector comprises a second heating sector and a third heating sector, each of the second and third heating sectors thermally coupled to a respective peripheral region of the build plate.

58. The system of claim 57, wherein each of the second heating sector and the third heating sector is configured to output the second heat flux, and wherein the first heat flux is less than the second heat flux.

59. (canceled)

60. The system of claim 55, wherein the first heating sector comprises a first heater and each of the at least one further heating sectors comprises a respective further heater.

61. The system of claim 60, wherein each of the first heater and the at least one further heater comprises a respective heating coil.

62. The system of claim 61, wherein a coil density of the heating coil of the first heater is less than a coil density of one or more of the at least one further heaters.

63. The system of claim 55, further comprising at least one of:
a thermal interface material disposed between the build plate heating assembly and the build plate;
an insulation layer thermally coupled to the build plate heating assembly; and
a cooling plate thermally coupled to the build plate heating assembly.

64.-66. (canceled)

67. The system of claim 55, further comprising at least one biasing member configured to bias the build plate and the build plate heating assembly together, the at least one biasing member comprising at least one of:
one or more springs cooperating with the build plate heating assembly to bias the build plate heating assembly toward the build plate; and
one or more clamp assemblies cooperating with the build plate to bias the build plate toward the build plate heating assembly and including at least a portion extending through the build plate heating assembly.

68.-70. (canceled)

71. A method for additive manufacturing, the method comprising:
applying a first heat flux to a first region of a build plate;
applying a second heat flux, different from the first heat flux, to at least one further region of the build plate;
depositing a layer of material on the build plate; and
directing laser energy onto the layer of material to selectively melt at least a portion of the layer of material.

72. The method of claim 71, wherein applying the first heat flux to the first region of the build plate comprises applying the first heat flux to a central region of the build plate, and wherein applying the second heat flux to the at least one further regions comprises applying the second heat flux to at least a first peripheral region and a second peripheral region of the build plate.

73. (canceled)

74. The method of claim 71, wherein the first heat flux is less than the second heat flux.

75. The method of claim 71, wherein applying the first heat flux comprises applying the first heat flux from a first heater, and wherein applying the second heat flux to the at least one further region comprises applying the second heat flux from at least one further heater.

76. The method of claim 71, wherein applying the first heat flux to the first region comprises conducting the first heat flux through a thermal interface material to the first region, and wherein conducting the first heat flux through the thermal interface material comprises conducting the first heat flux through a compliant thermal interface material.

77. (canceled)

78. The method of claim 71, the method further comprising at least one of:
insulating a support column coupled to the build plate; and
cooling a build plate support structure coupled to the build plate.

79. (canceled)

80. The method of claim 71, wherein applying the first and second heat flux comprises applying the first and second heat flux by a build plate heating assembly, the method further comprising at least one of:
biasing the build plate heating assembly toward the build plate; and
biasing the build plate toward the build plate heating assembly with a clamp assembly extending through the build plate heating assembly.

81.-83. (canceled)

84. The method of claim 71, further comprising fusing the melted portion of the powdered material to form one or more parts on the build plate.

85. A part manufactured using the method of claim 71.

86. An additive manufacturing system, comprising:
a build volume;
a build plate disposed within the build volume, the build plate including a build surface;
an optics assembly configured to direct laser energy toward the build surface; and
a build plate heating assembly thermally coupled to the build plate and configured to change a temperature of the build plate from a first temperature to a second temperature,
wherein the build plate is configured to have an unheated geometry at the first temperature and a heated geometry at the second temperature, and wherein the build surface is non-flat in the unheated geometry and flat in the heated geometry.

87.-94. (canceled)

95. A method for additive manufacturing, the method comprising:
heating a build plate of an additive manufacturing system from a first temperature to a second temperature to transform the build plate from an unheated geometry in which a build surface of the build plate is non-flat to a heated geometry in which the build surface is flat;
depositing a layer of powdered material on the build surface; and
directing laser energy toward the layer of powdered material to melt at least a portion of the layer of material.

96.-105. (canceled)

106. A mounting system for a build plate of an additive manufacturing system, the mounting system comprising:
a build plate having a build surface and a coupling surface opposite the build surface;
a build plate support structure in supportive contact with the coupling surface of the build plate, the build plate support structure configured to support the build plate during an additive manufacturing process; and
at least one clamp assembly, each clamp assembly including a coupling member extending between the build plate support structure and the build plate, each coupling member configured to engage with the coupling surface of the build plate, each clamp assembly configured to resiliently bias the build plate towards the build plate support structure when the coupling member is engaged with the build plate.

107. A method for additive manufacturing, the method comprising:
disposing a build plate adjacent to a build plate support structure within a build volume of an additive manufacturing system;
engaging at least one coupling member between the build plate support structure and the build plate; and
resiliently biasing the build plate, by the at least one coupling member, toward the build plate support structure.

108. An additive manufacturing system, comprising:
a build plate support structure comprising a base plate;
a build plate mounted to the base plate;
a build plate heating assembly disposed between the build plate and the base plate; and
at least one biasing member disposed between the build plate heating assembly and the base plate, the at least one biasing member in biasing contact with the build plate heating assembly to resiliently urge the build plate heating assembly towards the build plate.

109. A method for additive manufacturing, the method comprising:
disposing a build plate adjacent to a base plate of a build plate support structure within a build volume of an additive manufacturing system;
resiliently biasing a build plate heating assembly into thermal contact with the build plate;
heating the build plate, with the build plate heating assembly, from a first temperature to a second temperature;
depositing a layer of powdered material on the build plate; and
directing laser energy toward the layer of powdered material to selectively melt at least a portion of the layer of powdered material.
